(19) United States
(12) Patent Application Publication
(10) Pub. No.: US 2026/0246528 A1
(43) Pub. Date: Aug. 20, 2026

(54) INFORMATION REPORTING METHOD AND APPARATUS, INFORMATION RECEIVING METHOD AND APPARATUS, AND STORAGE MEDIUM

(71) Applicant: Beijing Xiaomi Mobile Software Co., Ltd., Beijing (CN)

(72) Inventor: Xueyuan GAO, Beijing (CN)

(21) Appl. No.: 19/471,230

(22) PCT Filed: Apr. 7, 2023
(86) PCT No.: PCT/CN2023/087049

§ 371 Date: Sep. 30, 2025

(51) Int. Cl. H04B 7/06; H04L 5/00; H04W 72/231; H04W 76/20

(52) U.S. Cl. CPC H04B 7/0697; H04L 5/0051; H04W 72/231; H04W 76/20

(57) ABSTRACT

A method for reporting information is provided. The method is performed by a terminal, and the method includes: sending indication information to a network device, where the indication information is configured to indicate a space division multiplexing (SDM) implementation supported by the terminal when the terminal performs simultaneous multi-panel uplink transmission.

### CROSS REFERENCE TO RELATED APPLICATION

The present application is a U.S. National Stage of International Application No. PCT/CN 2023/087049, filed on Apr. 7, 2023, the entire contents of which are incorporated herein by reference.

### BACKGROUND OF THE INVENTION

In Release 15 (R15) and Release 16 (R16), a Multi-Transmission Reception Point (M-TRP) scenario is not considered, and the uplink is single-TRP transmission. Release 17 (R17) enhances M-TRP uplink transmission under Single-Downlink Control Information (S-DCI). Among enhancement objectives of Release 18 (R18), it is mainly desired to achieve simultaneous collaborative transmission in TRP directions of a plurality of network devices via multiple panels on a terminal, so as to improve reliability and throughput rate of transmission.

### SUMMARY OF THE INVENTION

According to a first aspect of the embodiments of the present disclosure, a method for reporting information is provided. The method is performed by a terminal and includes:
sending indication information to a network device. The indication information is configured to indicate a space division multiplexing (SDM) implementation supported by the terminal when the terminal performs simultaneous multi-panel uplink transmission.

According to a second aspect of the embodiments of the present disclosure, a method for receiving information is provided. The method is performed by a network device and includes:
receiving indication information sent by a terminal, where the indication information is configured to indicate an SDM implementation supported by the terminal when the terminal performs simultaneous multi-panel uplink transmission; and
determining the SDM implementation supported by the terminal based on the indication information.

According to a third aspect of the embodiments of the present disclosure, a device for reporting information is provided, including:
a processor; and
a memory configured to store processor-executable instructions.

The processor is configured to send indication information to a network device. The indication information is configured to indicate an SDM implementation supported by a terminal when the terminal performs simultaneous multi-panel uplink transmission.

According to a fourth aspect of the embodiments of the present disclosure, a device for receiving information is provided, including:
a processor; and
a memory configured to store processor-executable instructions.

The processor is configured to perform the method for receiving information of the second aspect.

### BRIEF DESCRIPTION OF DRAWINGS

Accompanying drawings here are incorporated into the specification, constitute a part of the specification, show embodiments consistent with the present disclosure, and are used to explain the principle of the present disclosure together with the specification.

FIG. 1A is a schematic diagram of a multi-panel M-TRP transmission scenario of S-DCI scheduling according to an example.

FIG. 1B is a schematic diagram of a multi-panel M-TRP transmission scenario of multi-DCI scheduling according to an example.

FIG. 2 is a schematic diagram of a system architecture for reporting and receiving information according to an example.

FIG. 3A is a schematic diagram of an SDM implementation according to an example.

FIG. 3B is a schematic diagram of an SDM implementation according to another example.

FIG. 4 is a schematic flowchart of a method for reporting information according to an example.

FIG. 5 is a schematic flowchart of a method for reporting information according to another example.

FIG. 6 is a schematic flowchart of a method for receiving information according to an example.

FIG. 7 is a schematic flowchart of a method for receiving information according to another example.

FIG. 8A is a schematic flowchart of a method for reporting and receiving information according to an example.

FIG. 8B is a schematic flowchart of a method for reporting and receiving information according to another example.

FIG. 9 is a block diagram of a device for reporting information according to an example.

FIG. 10 is a block diagram of a device for receiving information according to an example.

FIG. 11 is a schematic diagram of a structure of a device for reporting information according to an example of the present disclosure.

FIG. 12 is a schematic diagram of a structure of a device for receiving information according to an example of the present disclosure.

### DETAILED DESCRIPTION OF THE INVENTION

Examples are illustrated in detail here, and their instances are shown in the accompanying drawings. When the following description refers to the accompanying drawings, unless otherwise indicated, the same numbers in different accompanying drawings indicate the same or similar elements. Implementations described in the following examples do not represent all implementations consistent with the present disclosure. Rather, they are merely instances of devices and methods consistent with some aspects of the present disclosure as detailed in the appended claims.

Terms used in the present disclosure are merely for the purpose of describing specific embodiments, and are not intended to limit the present disclosure. “One,” “a,” and “the” in singular forms used in the present disclosure and the appended claims are also intended to include plural forms unless other meanings are clearly indicated in the context. It is further to be understood that a term “and/or” as used herein refers to and includes any or all possible combinations of at least one associated listed item.

It is to be understood that although terms “first,” “second,” “third,” etc. may be used to describe various information in the present disclosure, such information is not to be limited to these terms. These terms are merely used to distinguish the same type of information from each other. For example, without departing from the scope of the present disclosure, a first message may also be referred to as a second message, and similarly, the second message may also be referred to as the first message. Depending on the context, for example, words “in a case where” as used here may be interpreted as “at the time,” “when,” or “in response to determining.”

In some embodiments, names of information, etc. are not limited to names recorded in the embodiments. Terms “Information,” “message,” “signal,” “signaling,” “report,” “configuration,” “indication,” “instruction,” “command,” “channel,” “parameter,” “domain,” “field,” “symbol,” “codebook,” “codeword,” “codepoint,” “bit,” “data,” “program,” “chip,” etc. are interchangeable.

In some embodiments, terms “codebook,” “codeword,” “precoding matrix,” etc. are interchangeable. For example, a codebook may be a collection of one or more codewords/precoding matrices.

In some embodiments, terms “access network device (AN device),” “radio access network device (RAN device),” “base station (BS),” “radio base station,” “fixed station,” “node,” “access point,” “transmission point (TP),” “reception point (RP),” “transmission/reception point (TRP),” “panel,” “antenna panel,” “antenna array,” “cell,” “macro cell,” “small cell,” “femto cell,” “pico cell,” “sector,” “cell group,” “service cell,” “carrier,” “component carrier,” “bandwidth part (BWP),” etc. are interchangeable.

Multi-antenna precoding of a Physical Uplink Shared Channel (PUSCH) supports two different mode configurations, one is codebook-based transmission, and the other is non-codebook-based transmission. A terminal or a network device may select a mode to be used based on whether reciprocity of uplink and downlink channels holds. The reciprocity refers to a fact that since uplink transmission and downlink transmission are performed at the same frequency in a Time Division Duplex (TDD) system, in a case where a sending time interval between the uplink and the downlink is short enough, fading of the uplink channel and the downlink channel may be considered to be essentially the same.

In a case where the reciprocity does not hold, the terminal or the network device may select the codebook-based transmission. In a case where the reciprocity holds, the terminal or the network device may select the codebook-based transmission or the non-codebook-based transmission.

Regardless of the precoding mode used by the terminal, the terminal needs to send a Sounding Reference Signal (SRS) for the network device to estimate Uplink Channel State Information (CSI).

The following introduces codebook-based PUSCH transmission and non-codebook-based PUSCH transmission in a single-TRP transmission scenario respectively.

### 1. Codebook-based PUSCH Transmission

In the codebook-based PUSCH transmission of a New Radio (NR) system, a network device needs to configure up to one SRS resource set for a terminal. The SRS resource set is used for codebook-based uplink transmission. A plurality of SRS resources may be included in the SRS resource set.

A network-side device may send an SRS Resources Indicator (SRI) to indicate an SRS resource selected by the network device for the terminal in the above SRS resource set. The SRI occupies ┌log₂(N_{SRS})┐ number of bits, and N_{SRS} refers to the number of the SRS resources included in the SRS resource set.

In addition, the network device determines, based on a measurement result of uplink CSI, a Transmitted Precoding Matrix Indicator (TPMI) and a transmission layer number actually used by the terminal for transmission, and informs the terminal.

In the following uplink transmission of the terminal, uplink data to be transmitted needs to be precoded using the PMI and the transmission layer number specified by the network-side device. In addition, the precoded data is mapped to a corresponding antenna port in accordance with a spatial filter corresponding to the SRS resource indicated by the SRI. Different SRSs are transmitted using different spatial filters, and thus the precoded data of the terminal needs to be filtered through the spatial filter used by the SRS indicated by the SRI. In this way, transmission of the uplink data from a single layer to a full rank may be supported.

The network device may indicate the TPMI and the transmission layer number based on a capability of the terminal. The capability of the terminal here is classified into three types, i.e., full coherent, partial coherent, and non-coherent, characterizing a capability of coherence of antenna ports.

The NR system defines three kinds of antenna coherent transmission capabilities of the terminal:

Full coherent, in which all antennas of the terminal may transmit coherently;

Partial coherent, in which antennas within the same coherent transmission pair of the terminal may transmit coherently, but coherent transmission cannot be performed between coherent transmission pairs; and

Non-coherent, in which no antenna of the terminal may transmit coherently.

For example, it is assumed that the NR system allows the network device to configure two SRS resources for the terminal, and the two SRS resources are used for the terminal to perform channel sounding based on codebook uplink transmission. The two SRS resources include the same number of SRS antenna ports and have the same time-domain type, i.e., the two SRS resources are both periodic SRSs, semi-continuous SRSs, or aperiodic SRSs. In a case where the network device configures two SRS resources for the terminal for codebook-based uplink transmission, the network device may indicate one SRS resource corresponding to the TPMI and the transmission layer number to the terminal via the SRI.

### 2. Non-Codebook-Based PUSCH Transmission

The terminal may first send the capability of the terminal to the network device, and the capability of the terminal is configured to indicate the maximum number of SRS resources supported by the terminal that may be transmitted simultaneously.

Assuming that the network device sends the SRI to the terminal at a slot n, it is configured to indicate an effective resource of the most recent SRS transmission before the slot n.

The terminal may determine the TPMI according to a maximum transmission layer number (maxRank) in a higher-layer parameter PUSCH configuration (PUSCH-Config). The number of SRS resources indicated by the SRI is less than or equal to maxRank.

The network device may configure an associated Channel State Information-Reference Signal (CSI-RS) resource used for channel measurement for an SRS resource set used for non-codebook-based uplink transmission. The terminal obtains a precode of SRS transmission in the SRS resource set used for the non-codebook uplink transmission according to the associated CSI-RS resource.

For the non-codebook-based uplink transmission, a downlink configured CSI-RS generally needs to be measured in an actual system. The terminal obtains uplink channel information by measurement of the downlink signal using uplink and downlink reciprocity. Included processes are mainly as follows.

The network-side device configures the associated downlink CSI-RS for the non-codebook-based transmission for downlink channel sounding of the terminal;
the terminal selects the precoding matrix by a calculation of the downlink channel, and simultaneously sends an SRS in each precoded beam direction on the configured SRS resource set;
the network-side device performs uplink channel detection on the SRS, and the network-side device simultaneously performs resource scheduling for the terminal and informs the terminal via downlink signaling, and simultaneously selects a beam in the precoding matrix by the SRI; and
the terminal determines an actual precode and an allowed layer number using a modified precoding matrix, and sends the PUSCH. The terminal determines the TPMI according to the higher-layer parameter maxRank. The number of SRS resources indicated by the SRI is not greater than max Rank.

In order to enable the network to modify the precoding matrix actually used by the terminal, for the non-codebook-based transmission, the network needs to configure one SRS resource set for the terminal.

For a non-codebook transmission scheme, the network-side device may configure one SRS resource set for the terminal. The SRS resource set includes one to four SRS resources, and each SRS resource includes one SRS port. In a case where the network-side device configures a plurality of SRS resources for the terminal for non-codebook uplink transmission, the plurality of SRS resources have the same time-domain type, i.e., all the SRS resources are periodic SRSs, semi-continuous SRSs, or aperiodic SRSs. The network device may indicate, via the SRI, one or more SRS resources to the terminal for determination of the PUSCH precode. The number of SRS resources corresponding to the SRI is the number of streams for PUSCH transmission. In a case where the network device configures merely one SRS resource for the terminal for non-codebook uplink transmission, DCI used to perform an uplink authorization may not include an SRI domain.

The uplink PUSCH transmission is transmission in TRP directions of a plurality of network devices. Collaborative transmission in a TDM transmission mode is mainly standardized in R17. Different repetitions of the same information on the PUSCH are sent to different TRPs of the network device via different Transmission Occasions (TOs) of the time domain in a time division manner. This method has lower requirements for the capability of the terminal, does not require a capability to support simultaneous transmission of beams, and has a larger transmission delay.

For the uplink, in PUSCH channels oriented to different TRPs, spatial characteristics of the channels actually passed through may vary greatly, and thus quasi-co-locations of the PUSCH channels in different transmission directions are considered to be different.

An M-TRP scenario is not considered in R15 and R16, and the uplink is single-TRP transmission. R17 enhances M-TRP uplink transmission under S-DCI. The uplink PUSCH transmission is transmission in TRP directions of a plurality of network devices. Collaborative transmission in a TDM transmission mode is mainly standardized in R17. Different repetitions of the same information on the PUSCH are sent to different TRPs of the network device via different TOs of the time domain in a time division manner. This method has lower requirements for the capability of the terminal, each TO simply needs to send a PUSCH in one TRP direction, thus a capability to support simultaneous transmission of beams is not required, and the transmission delay is larger.

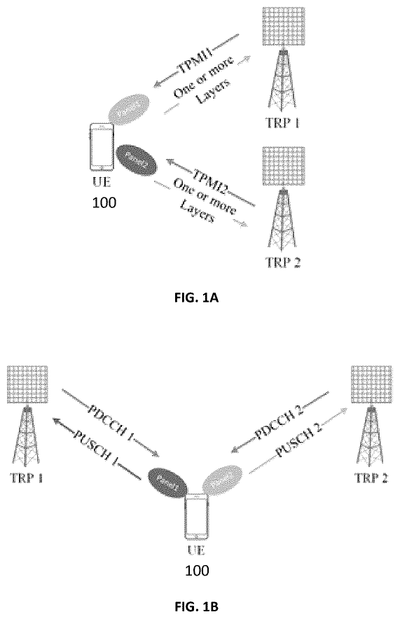

Among enhancement objectives of R18, it is mainly desired to achieve simultaneous collaborative transmission in TRP directions of a plurality of network devices via multiple panels of the terminal (such as UE 100 shown in FIG. 1A and FIG. 1B), so as to improve reliability and throughput rate of transmission. In addition, the transmission delay under the plurality of TRPs may be effectively reduced, but the terminal is required to have a capability to send a plurality of beams simultaneously. Transmission of the PUSCH may be based on multi-panel M-TRP transmission scheduled by a single PDCCH, i.e., S-DCI, such as shown in FIG. 1A, or may be based on multi-panel M-TRP transmission scheduled by multi-DCI, such as shown in FIG. 1B.

The terminal is generally configured with a plurality of physical panels. Different panels may have different capabilities, for example, may have different numbers of SRS ports. Supported maximum data transmission layer numbers may not be the same, for example, one panel supports transmission of up to 2 layers, and another panel supports transmission of up to 4 layers. A network scheduler determines whether the terminal is currently suitable for simultaneous multi-panel uplink transmission. In a case where the terminal is currently suitable for the simultaneous multi-panel uplink transmission and is scheduled at the same time, the network directly or indirectly indicates relevant transmission parameters, including terminal specific beam indication information, the number of data layers used for the transmission, port assignment of the used Demodulation Reference Signal (DMRS), precoded indication information, etc.

In R18, transmission schemes supported by simultaneous uplink transmission (STxMP) for an S-DCI-based PUSCH include the following schemes.

In an SDM scheme, different parts of one transmission block of the PUSCH are respectively sent on the same time-frequency resource towards two different TRPs through respective corresponding DMRS ports or combinations of ports allocated on different panels, and different panels, TRPs, and TOs are respectively associated with different beams.

In a Single Frequency Network (SFN) SDM scheme, one transmission block of the PUSCH is respectively sent on the same time-frequency resource towards two different TRPs through the same DMRS port or combination of ports allocated on different panels, and different panels, TRPs, and TOs are respectively associated with different beams.

In uplink enhancement of R18, how to support a higher uplink throughput rate and more reliable transmission performance by multi-panel M-TRP simultaneous uplink transmission is considered.

Currently, in a standardization discussion of multi-panel simultaneous uplink transmission in R18, S-DCI-based SDM and SFN transmission schemes of the PUSCH are supported. Currently, symmetric panels may be supported to achieve R18 STxMP. Considering that specific processing and implementations of the terminal are different, i.e., corresponding SDM implementation schemes are different, how the terminal reports an SDM implementation supported by the terminal is a problem that needs to be further solved.

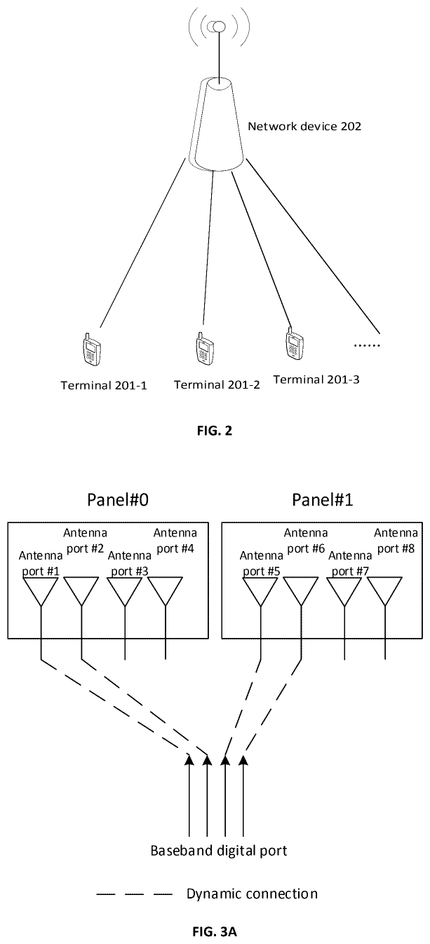

The present disclosure provides a method and device for reporting information, a method and device for receiving information, and a storage medium as follows. As shown in FIG. 2, it is a schematic diagram of a network architecture diagram to which the solution of the present disclosure is applicable. A network in the present disclosure may be a 4G network, a 5G network, a 6G network, or a future communication network, etc., which is not limited in the present disclosure. The network architecture includes a terminal 201 and a network device 202.

The terminal 201 (201-1, 201-2, 201-3 . . . included in FIG. 2) may be a smartphone, a desktop computer, a laptop computer, a tablet computer, etc., which is not limited in the present disclosure. Multiple panels are deployed on the terminal 201.

The network device 202 includes, but is not limited to, a base station, an access network device, etc. The base station may be a 4G base station, a 5G base station, or a future 6G base station, and the access network device may be a 4G access network device, a 5G access network device, or a future 6G access network device, etc., which is not limited in the present disclosure.

In some embodiments, the terminal 201 reports indication information to the network device 202. The indication information is configured to indicate an SDM implementation supported by the terminal when the terminal performs simultaneous multi-panel uplink transmission.

The network device 202 may determine the SDM implementation supported by the terminal based on the indication information.

In one possible implementation, the SDM implementation supported by the terminal includes a first SDM implementation. Specifically, the first SDM implementation includes: a plurality of antenna ports deployed on multiple panels sharing a first number of baseband digital ports on the terminal. In such case, the number of the baseband digital ports is less than or equal to the total number of the antenna ports.

For example, as shown in FIG. 3A, it is assumed that there are totally four baseband digital ports on the terminal, digital port #1 to digital port #4 respectively. Two panels are deployed on the terminal, panel #0 and panel #1 respectively. Each panel includes four antenna ports, antenna port #1 to antenna port #8 respectively. Antenna port #1 to antenna port #8 share four digital ports, i.e., the connection mode between the antenna ports and the digital ports is not fixed and may be dynamically scheduled by the network device.

In another possible implementation, the SDM implementation supported by the terminal includes a second SDM implementation. Specifically, the second SDM implementation includes: the first number of antenna ports deployed on the multiple panels being in a one-to-one correspondence with the first number of baseband digital ports. The first number of antenna ports are fixedly connected with the first number of baseband digital ports.

For example, as shown in FIG. 3B, in such case, the connection relationship between the antenna ports and the baseband digital ports cannot be changed.

In one possible implementation, the terminal 201 may report one SDM implementation supported by the terminal 201 to the network device 202 via terminal capability indication information.

In another possible implementation, the terminal 201 may report first layer number indication information to the network device 202. The first layer number indication information is configured to indicate a maximum transmission layer number supported for use by the terminal when the terminal is configured for the simultaneous multi-panel uplink transmission.

The terminal 201 determines the number and specific values of maximum transmission layer numbers reported in the first layer number indication information based on the supported SDM implementation. The network device 202 may determine the SDM implementation supported by the terminal 201 based on the first layer number indication information. The specific determination mode is introduced in subsequent embodiments and is not introduced here.

In the above embodiment, after determining the SDM implementation supported by the terminal 201, the network device 202 may configure an SRS resource set for the terminal 201 based on the SDM implementation, which improves the feasibility and reliability of the simultaneous multi-panel uplink transmission.

The method for reporting information provided by the present disclosure is introduced below first from a terminal side.

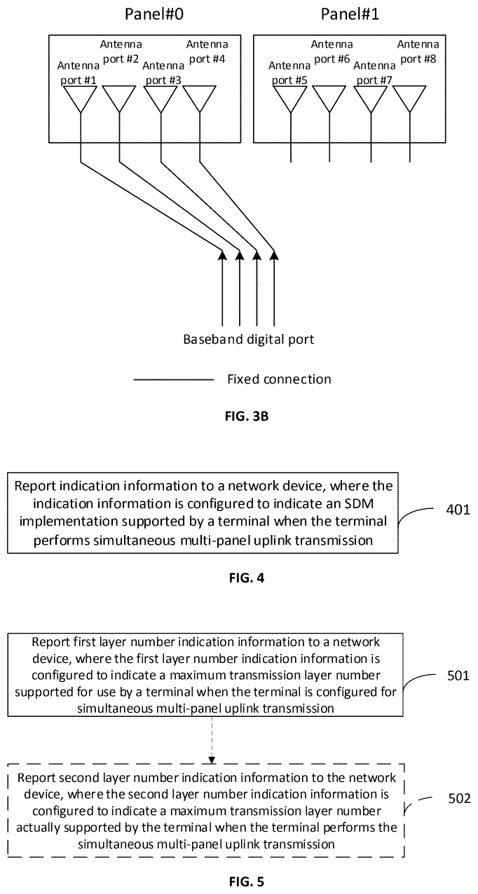

An embodiment of the present disclosure provides a method for reporting information, as shown with reference to FIG. 4, which is a flowchart of a method for reporting information according to an embodiment. The method may be performed by a terminal, and may include the following step 401.

In step 401, indication information is reported to a network device. The indication information is configured to indicate an SDM implementation supported by the terminal when the terminal performs simultaneous multi-panel uplink transmission.

In the embodiment of the present disclosure, the terminal may achieve a purpose of supporting SDM transmission in at least one of a software or hardware mode.

In one possible implementation, the SDM implementation is any one of a first SDM implementation or a second SDM implementation.

The first SDM implementation includes: a plurality of antenna ports deployed on multiple panels sharing a first number of baseband digital ports on the terminal, e.g., as shown in FIG. 3A.

The second SDM implementation includes: the first number of antenna ports deployed on the multiple panels being in a one-to-one correspondence with the first number of baseband digital ports. The first number of antenna ports are fixedly connected with the first number of baseband digital ports, and the connection association cannot be changed, e.g., as shown in FIG. 3B.

In one possible implementation, the terminal may report terminal capability information to the network device via radio resource control (RRC) signaling. The terminal capability indication information is configured to indicate one SDM implementation supported by the terminal.

For example, the terminal reports the terminal capability information via the RRC signaling, and the terminal capability indication information is configured to indicate that the terminal supports the first SDM implementation.

For example, the terminal reports the terminal capability information via the RRC signaling, and the terminal capability indication information is configured to indicate that the terminal supports the second SDM implementation.

In one example, the terminal may report one supported SDM implementation to the network device via an Information Element (IE) in the RRC signaling, for example:

UL_STxMP_SDMscheme {“scheme1”, “scheme2”}

where scheme1 is configured to indicate the first SDM implementation, and scheme2 is configured to indicate the second SDM implementation.

In another possible implementation, instead of directly reporting one SDM implementation supported by the terminal, the terminal may implicitly indicate one SDM implementation supported by the terminal via other reported information.

In some examples, the terminal may inform the network device of one SDM implementation supported by the terminal by reporting first layer number indication information. The first layer number indication information is configured to indicate a maximum transmission layer number supported for use by the terminal when the terminal is configured for the simultaneous multi-panel uplink transmission.

The terminal may be supported to perform single-TRP transmission and M-TRP transmission under a configuration of Simultaneous Multi-panel uplink transmission (STxMP). In the present disclosure, the M-TRP transmission mainly refers to an SDM transmission implementation.

In one example, the number of the maximum transmission layer numbers reported by the terminal via the first layer number indication information may be a plurality. In such case, the first layer number indication information may be configured to respectively indicate:
a maximum transmission layer number supported by the terminal during the single-TRP transmission; and
a maximum transmission layer number supported by the terminal when the terminal performs SDM transmission of the simultaneous multi-panel uplink transmission during the M-TRP transmission.

In the present disclosure, the maximum transmission layer number refers to a maximum Multiple-Input Multiple-Output (MIMO) transmission layer number configured by the network device for the terminal. The maximum transmission layer number is a maximum transmission layer number of the PUSCH.

For example, the terminal indicates, via maxRank, a maximum transmission layer number supported by the terminal during Contention-Based (CB) PUSCH transmission. The terminal may report maxRank-sTPR and maxRank-SDM. maxRank-sTPR is used for CB PUSCH transmission, and is configured to indicate the maximum transmission layer number supported by the terminal during the single-TRP transmission. maxRank-SDM is used for CB PUSCH transmission, and is configured to indicate the maximum transmission layer number supported by the terminal when the terminal performs the SDM transmission of the simultaneous multi-panel uplink transmission during the M-TRP transmission.

For example, the terminal indicates, via L_max, a maximum transmission layer number supported by the terminal during Non Contention-Based (NCB) PUSCH transmission. The terminal may report L_max-sTPR and L_max-SDM. L_max-sTPR is used for NCB PUSCH transmission, and is configured to indicate the maximum transmission layer number supported by the terminal during the single-TRP transmission. L_max-SDM is used for NCB PUSCH transmission, and is configured to indicate the maximum transmission layer number supported by the terminal when the terminal performs the SDM transmission of the simultaneous multi-panel uplink transmission during the M-TRP transmission.

For example, in a case where the terminal determines that the supported SDM implementation is the first SDM implementation, the number of the maximum transmission layer numbers indicated by the first layer number indication information reported to the network device may be a plurality, and the plurality of maximum transmission layer numbers are not equal.

For example, the terminal determines that the supported SDM implementation is the first SDM implementation. The terminal reports the first layer number indication information, which includes max Rank-sTPR=4 and max Rank-SDM=2.

For another example, the terminal determines that the supported SDM implementation is the first SDM implementation. The terminal reports the first layer number indication information, which includes L_max-sTPR=4 and L_max-SDM=2.

The above is merely an example illustration. In an actual application, the terminal may also report the first layer number indication information including other contents after determining the supported SDM implementation, which is not limited in the present disclosure.

For example, in a case where the terminal determines that the supported SDM implementation is the second SDM implementation, the number of the maximum transmission layer numbers indicated by the first layer number indication information reported to the network device may be a plurality, and the plurality of maximum transmission layer numbers are equal.

For example, the terminal determines that the supported SDM implementation is the second SDM implementation. The terminal reports the first layer number indication information, which includes max Rank-sTPR=2 and maxRank-SDM=2.

For another example, the terminal determines that the supported SDM implementation is the second SDM implementation. The terminal reports the first layer number indication information, which includes L_max-sTPR=2 and L_max-SDM=2.

In another example, the number of the maximum transmission layer numbers reported by the terminal via the first layer number indication information may be 1. In such case, the first layer number indication information may be configured to indicate:
the maximum transmission layer number supported for use by the terminal during the single-TRP transmission being equal to the maximum transmission layer number supported for use by the terminal during the SDM transmission of the simultaneous multi-panel uplink transmission.

For example, the terminal may indicate the SDM implementation supported by the terminal via the reported number of the maximum transmission layer numbers.

For example, in a case where the terminal determines that the supported SDM implementation is the first SDM implementation, the number of the maximum transmission layer numbers indicated by the first layer number indication information reported to the network device may be a plurality. In such case, the plurality of maximum transmission layer numbers may be equal or may not be equal.

For example, the terminal determines that the supported SDM implementation is the first SDM implementation. The terminal reports the first layer number indication information, which includes maxRank-sTPR=4 and maxRank-SDM=2, or includes L_max-sTPR=2 and L_max-SDM=2.

For example, in a case where the terminal determines that the supported SDM implementation is the second SDM implementation, the number of the maximum transmission layer numbers indicated by the first layer number indication information reported to the network device may be 1.

For example, the terminal determines that the supported SDM implementation is the second SDM implementation. The terminal reports the first layer number indication information, which includes maxRank=2. In such case, the first layer number indication information indicates maxRank-sTPR=max Rank-SDM=2.

In the above embodiment, the terminal may report the SDM implementation supported by the terminal to the network device in different modes, such that the network device may subsequently configure resources for the terminal based on the SDM implementation supported by the terminal, which improves the feasibility and reliability of the simultaneous multi-panel uplink transmission.

In some embodiments, as shown with reference to FIG. 5, it is a flowchart of a method for reporting information according to an embodiment. The method may be performed by a terminal, and may include the following steps 501 and 502.

In step 501, first layer number indication information is reported to a network device. The first layer number indication information is configured to indicate a maximum transmission layer number supported for use by the terminal in a case where the terminal is configured for simultaneous multi-panel uplink transmission.

The specific implementation has been introduced in the above step 401 and is not repeated here.

In step 502, second layer number indication information is reported to the network device. The second layer number indication information is configured to indicate a maximum transmission layer number actually supported by the terminal when the terminal performs the simultaneous multi-panel uplink transmission.

In the embodiment of the present disclosure, the maximum transmission layer number indicated by the first layer number indication information is determined by the capability of the terminal, and the maximum transmission layer number supported by the terminal during actual transmission may be less than or equal to the maximum transmission layer number indicated by the first layer number indication information.

In a possible implementation, step 502 is an optional step to be performed. In a case where the maximum transmission layer number actually supported by the terminal when the terminal performs the simultaneous multi-panel uplink transmission is the same as the maximum transmission layer number indicated by the first layer number indication information reported by the terminal, the terminal may not perform step 502.

For example, in a case where the maximum transmission layer number actually supported by the terminal during single-TRP transmission is the same as the maximum transmission layer number supported by the terminal during the single-TRP transmission, which is reported by the terminal, and the maximum transmission layer number actually supported by the terminal when the terminal performs SDM transmission of the simultaneous multi-panel uplink transmission during M-TRP transmission is the same as the maximum transmission layer number supported by the terminal when the terminal performs the SDM transmission of the simultaneous multi-panel uplink transmission during the M-TRP transmission, which is reported by the terminal, the terminal may not perform step 502.

In another possible implementation, in a case where the maximum transmission layer number actually supported by the terminal when the terminal performs the simultaneous multi-panel uplink transmission is different from the maximum transmission layer number indicated by the first layer number indication information reported by the terminal, the terminal may perform step 502.

For example, in a case where the maximum transmission layer number actually supported by the terminal during the single-TRP transmission is different from the maximum transmission layer number supported by the terminal during the single-TRP transmission, which is reported by the terminal, and/or, the maximum transmission layer number actually supported by the terminal when the terminal performs the SDM transmission of the simultaneous multi-panel uplink transmission during the M-TRP transmission is different from the maximum transmission layer number supported by the terminal when the terminal performs the SDM transmission of the simultaneous multi-panel uplink transmission during the M-TRP transmission, which is reported by the terminal, the terminal may perform step 502 and report the second layer number indication information to the network device.

For example, the maximum transmission layer number actually supported by the terminal is represented by maxRank'. Assuming that the terminal reports the first layer number indication information, which includes maxRank-sTRP=2 and maxRank-SDM=2, and the maximum transmission layer number actually supported by the terminal when the terminal performs the SDM transmission of the simultaneous multi-panel uplink transmission is 1, then the terminal reports the second layer number indication information, which includes maxRank′-STRP=2 and maxRank′-SDM=1.

For another example, assuming that the terminal reports the first layer number indication information, which includes maxRank-sTRP=2 and maxRank-SDM=2, and the maximum transmission layer number actually supported by the terminal during the single-TRP transmission is 1, then the terminal reports the second layer number indication information, which includes maxRank′-sTRP=1 and maxRank′-SDM=2.

For another example, assuming that the terminal reports the first layer number indication information, which includes maxRank-sTRP=2 and maxRank-SDM=2, the maximum transmission layer number actually supported by the terminal during the single-TRP transmission is 1, and the maximum transmission layer number actually supported by the terminal when the terminal performs the SDM transmission of the simultaneous multi-panel uplink transmission is 1, then the terminal reports the second layer number indication information, which includes maxRank′-sTRP=1 and maxRank′-SDM=1.

The above is merely an example illustration. The terminal may also perform step 502 in response to determining that the maximum transmission layer number actually supported by the terminal indicated by the second layer number indication information is the same as the maximum transmission layer number indicated by the first layer number indication information, which is not limited in the present disclosure.

In the above embodiment, the terminal may report the actually supported maximum transmission layer number when performing the simultaneous multi-panel uplink transmission to the network device, which improves accuracy of configuring an SRS resource set by the network device, and has a high availability.

A method for receiving information provided by the present disclosure is further introduced below from a network device side.

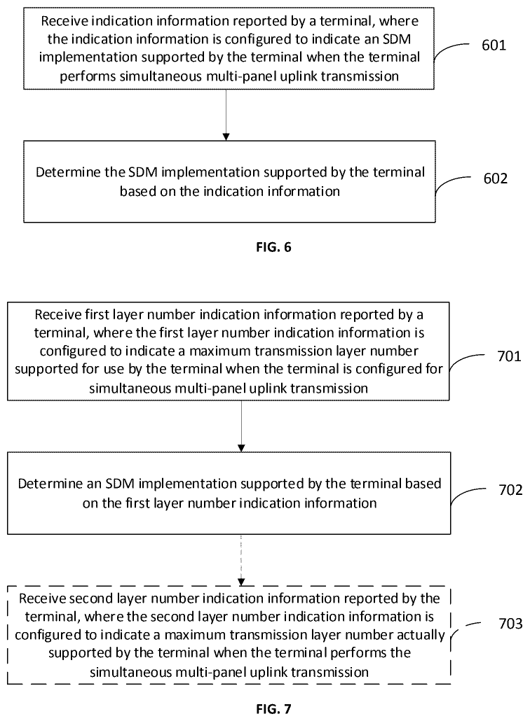

An embodiment of the present disclosure provides a method for receiving information, as shown with reference to FIG. 6, which is a flowchart of a method for receiving information according to an embodiment. The method may be performed by a network device. The network device includes, but is not limited to, a base station, an access network device, etc. The base station may be a 4G base station, a 5G base station, or a future 6G base station, and the access network device may be a 4G access network device, a 5G access network device, or a future 6G access network device, etc., which is not limited in the present disclosure. The method may include the following steps 601 and 602.

In step 601, indication information reported by a terminal is received. The indication information is configured to indicate an SDM implementation supported by the terminal when the terminal performs simultaneous multi-panel uplink transmission.

In one possible implementation, the terminal achieves a purpose of supporting SDM transmission in at least one of a software or hardware mode. Specifically, the SDM implementation supported by the terminal is any one of a first SDM implementation or a second SDM implementation.

The first SDM implementation includes: a plurality of antenna ports deployed on multiple panels sharing a first number of baseband digital ports on the terminal, e.g., as shown in FIG. 3A.

The second SDM implementation includes: the first number of antenna ports deployed on the multiple panels being in a one-to-one correspondence with the first number of baseband digital ports. The first number of antenna ports are fixedly connected with the first number of baseband digital ports, and the connection association cannot be changed, e.g., as shown in FIG. 3B.

In one possible implementation, the network device may receive terminal capability information reported by the terminal via RRC signaling. The terminal capability indication information is configured to indicate one SDM implementation supported by the terminal.

For example, the network device receives the terminal capability information reported by the terminal via the RRC signaling. The terminal capability indication information is configured to indicate that the terminal supports the first SDM implementation.

For example, the network device receives the terminal capability information reported by the terminal via the RRC signaling. The terminal capability indication information is configured to indicate that the terminal supports the second SDM implementation.

In one example, the network device may receive one SDM implementation supported by the terminal reported by the terminal via an IE in the RRC signaling, for example:

UL_STxMP_SDMscheme {“scheme1”, “scheme2”}

where scheme1 is configured to indicate the first SDM implementation, and scheme2 is configured to indicate the second SDM implementation.

In another possible implementation, the terminal may not directly report one SDM implementation supported by the terminal. The network device may determine one SDM implementation supported by the terminal via other information reported by the terminal.

In some examples, the network device may receive first layer number indication information reported by the terminal, and thus determine one SDM implementation supported by the terminal. The first layer number indication information is configured to indicate a maximum transmission layer number supported for use by the terminal when the terminal is configured for the simultaneous multi-panel uplink transmission.

The terminal may be supported to perform single-TRP transmission and M-TRP transmission under a configuration of simultaneous multi-panel uplink transmission. In the present disclosure, the M-TRP transmission mainly refers to an SDM transmission implementation.

In one example, the number of the maximum transmission layer numbers reported by the terminal via the first layer number indication information may be a plurality. In such case, the first layer number indication information may be configured to respectively indicate:
a maximum transmission layer number supported by the terminal during the single-TRP transmission; and
a maximum transmission layer number supported by the terminal when the terminal performs SDM transmission of the simultaneous multi-panel uplink transmission during the M-TRP transmission.

In the present disclosure, the maximum transmission layer number refers to a maximum MIMO transmission layer number configured by the network device for the terminal. The maximum transmission layer number is a maximum transmission layer number of the PUSCH.

In one example, the number of the maximum transmission layer numbers reported by the terminal via the first layer number indication information is a plurality. The first layer number indication information may be configured to respectively indicate:
the maximum transmission layer number supported by the terminal during the single-TRP transmission; and
the maximum transmission layer number supported by the terminal when the terminal performs the SDM transmission of the simultaneous multi-panel uplink transmission during the M-TRP transmission.

In another example, the number of the maximum transmission layer numbers reported by the terminal via the first layer number indication information may be 1. In such case, the first layer number indication information may be configured to indicate:
the maximum transmission layer number supported for use by the terminal during the single-TRP transmission being equal to the maximum transmission layer number supported for use by the terminal during the SDM transmission of the simultaneous multi-panel uplink transmission.

In step 602, the SDM implementation supported by the terminal is determined based on the indication information.

In one possible implementation, the network device may directly determine the SDM implementation supported by the terminal based on the terminal capability indication information reported by the terminal.

For example, the terminal indicates “scheme1” in the IE of the RRC signaling, and then the network device determines that the SDM implementation supported by the terminal is the first SDM implementation. For another example, the terminal indicates “scheme2” in the IE, and then the network device determines that the SDM implementation supported by the terminal is the second SDM implementation.

In another possible implementation, the network device determines the SDM implementation supported by the terminal based on the first layer number indication information reported by the terminal.

In one example, in a case of determining that the number of the maximum transmission layer numbers indicated by the first layer number indication information reported by the terminal is a plurality, the network device may determine the SDM implementation supported by the terminal based on whether the plurality of maximum transmission layer numbers are the same.

For example, in a case of determining that the number of the maximum transmission layer numbers indicated by the first layer number indication information reported by the terminal is a plurality and the plurality of maximum transmission layer numbers are not equal, the network device may determine that the SDM implementation supported by the terminal is the first SDM implementation.

For example, the first layer number indication information reported by the terminal includes maxRank-sTPR=4 and maxRank-SDM=2. Since maxRank-sTPR and maxRank-SDM are not equal, the network device determines that the SDM implementation supported by the terminal is the first SDM implementation.

For example, in a case of determining that the number of the maximum transmission layer numbers indicated by the first layer number indication information reported by the terminal is a plurality and the plurality of maximum transmission layer numbers are equal, the network device may determine that the SDM implementation supported by the terminal is the second SDM implementation.

For example, the first layer number indication information reported by the terminal includes maxRank-sTPR=2 and max Rank-SDM=2. Since maxRank-sTPR and maxRank-SDM are equal, the network device determines that the SDM implementation supported by the terminal is the second SDM implementation.

In another example, the network device determines the SDM implementation supported by the terminal based on the number of the maximum transmission layer numbers indicated by the first layer number indication information reported by the terminal.

For example, in a case of determining that the number of the maximum transmission layer numbers indicated by the first layer number indication information reported by the terminal is a plurality, the network device may determine that the SDM implementation supported by the terminal is the first SDM implementation.

For example, the first layer number indication information reported by the terminal includes max Rank-sTPR=4 and maxRank-SDM=2. Since the number of the maximum transmission layer numbers indicated by the first layer number indication information is a plurality, the network device determines that the SDM implementation supported by the terminal is the first SDM implementation.

For example, in a case of determining that the number of the maximum transmission layer numbers indicated by the first layer number indication information reported by the terminal is 1, the network device may determine that the SDM implementation supported by the terminal is the second SDM implementation.

For example, the first layer number indication information reported by the terminal includes maxRank=2. Since the number of the maximum transmission layer numbers indicated by the first layer number indication information is 1, the network device determines that the SDM implementation supported by the terminal is the second SDM implementation. In such case, the first layer number indication information indicates maxRank-sTPR=maxRank-SDM=2.

In the above embodiment, the network device may quickly determine the SDM implementation supported by the terminal based on different indication information reported by the terminal, so as to configure an SRS resource set for the terminal based on the SDM implementation, which improves the feasibility and reliability of the simultaneous multi-panel uplink transmission.

In some embodiments, as shown with reference to FIG. 7, it is a flowchart of a method for receiving information according to an embodiment. The method may be performed by a network device. The network device includes, but is not limited to, a base station, an access network device, etc. The base station may be a 4G base station, a 5G base station, or a future 6G base station, and the access network device may be a 4G access network device, a 5G access network device, or a future 6G access network device, etc., which is not limited in the present disclosure. The method may include the following steps 701 to 703.

In step 701, first layer number indication information reported by a terminal is received. The first layer number indication information is configured to indicate a maximum transmission layer number supported for use by the terminal in a case where the terminal is configured for simultaneous multi-panel uplink transmission.

In some examples, the network device may receive the first layer number indication information reported by the terminal, and thus determine one SDM implementation supported by the terminal. The first layer number indication information is configured to indicate the maximum transmission layer number supported for use by the terminal in a case where the terminal is configured for the simultaneous multi-panel uplink transmission.

The terminal may be supported to perform single-TRP transmission and M-TRP transmission under a configuration of simultaneous multi-panel uplink transmission. In the present disclosure, the M-TRP transmission mainly refers to an SDM transmission implementation.

In one example, the number of the maximum transmission layer numbers reported by the terminal via the first layer number indication information is a plurality. The first layer number indication information may be configured to respectively indicate:

a maximum transmission layer number supported by the terminal during the single-TRP transmission; and
a maximum transmission layer number supported by the terminal when the terminal performs SDM transmission of the simultaneous multi-panel uplink transmission during the M-TRP transmission.

In the present disclosure, the maximum transmission layer number refers to a maximum MIMO transmission layer number configured by the network device for the terminal. The maximum transmission layer number is a maximum transmission layer number of the PUSCH.

In one example, the number of the maximum transmission layer numbers reported by the terminal via the first layer number indication information is a plurality. The first layer number indication information may be configured to respectively indicate:
the maximum transmission layer number supported by the terminal during the single-TRP transmission; and
the maximum transmission layer number supported by the terminal when the terminal performs the SDM transmission of the simultaneous multi-panel uplink transmission during the M-TRP transmission.

In another example, in a case where the number of the maximum transmission layer numbers reported by the terminal via the first layer number indication information is 1, the first layer number indication information may be configured to indicate:
the maximum transmission layer number supported for use by the terminal during the single-TRP transmission being equal to the maximum transmission layer number supported for use by the terminal during the SDM transmission of the simultaneous multi-panel uplink transmission.

In step 702, the SDM implementation supported by the terminal is determined based on the first layer number indication information.

The implementation of step 702 is similar to the process of determining the SDM implementation supported by the terminal based on the first layer number indication information in the above step 602, which is not repeated here.

In step 703, second layer number indication information reported by the terminal is received. The second layer number indication information is configured to indicate a maximum transmission layer number actually supported by the terminal when the terminal performs the simultaneous multi-panel uplink transmission.

In the embodiment of the present disclosure, the maximum transmission layer number indicated by the first layer number indication information is determined by the capability of the terminal, and the maximum transmission layer number supported by the terminal during actual transmission may be less than or equal to the maximum transmission layer number indicated by the first layer number indication information.

In a possible implementation, step 703 is an optional step to be performed. In a case where the maximum transmission layer number actually supported by the terminal when the terminal performs the simultaneous multi-panel uplink transmission is the same as the maximum transmission layer number indicated by the first layer number indication information reported by the terminal, the network device does not receive the second layer number indication information. In such case, the network device determines that the maximum transmission layer number actually supported by the terminal when the terminal performs the simultaneous multi-panel uplink transmission is the same as the maximum transmission layer number indicated by the first layer number indication information reported by the terminal.

For example, in a case where the network device does not receive the second layer number indication information, the network device determines that the maximum transmission layer number actually supported by the terminal during the single-TRP transmission is the same as the maximum transmission layer number supported by the terminal during the single-TRP transmission, which is reported by the terminal, and the maximum transmission layer number actually supported by the terminal when the terminal performs SDM transmission of the simultaneous multi-panel uplink transmission during M-TRP transmission is the same as the maximum transmission layer number supported by the terminal when the terminal performs the SDM transmission of the simultaneous multi-panel uplink transmission during the M-TRP transmission, which is reported by the terminal.

In another possible implementation, in a case where the network device receives the second layer number indication information, the network device determines that the maximum transmission layer number actually supported by the terminal when the terminal performs the simultaneous multi-panel uplink transmission is different from the maximum transmission layer number indicated by the first layer number indication information reported by the terminal.

For example, the network device receives the second layer number indication information, and the network device may determine that the maximum transmission layer number actually supported by the terminal during the single-TRP transmission is different from the maximum transmission layer number supported by the terminal during the single-TRP transmission, which is reported by the terminal, and/or, the maximum transmission layer number actually supported by the terminal when the terminal performs the SDM transmission of the simultaneous multi-panel uplink transmission during the M-TRP transmission is different from the maximum transmission layer number supported by the terminal when the terminal performs the SDM transmission of the simultaneous multi-panel uplink transmission during the M-TRP transmission, which is reported by the terminal.

For example, the maximum transmission layer number actually supported by the terminal is represented by maxRank'. Assuming that the terminal reports the first layer number indication information, which includes maxRank-sTRP=2 and maxRank-SDM=2, the network device receives the second layer number indication information reported by the terminal, which includes maxRank′-sTRP=2 and maxRank′-SDM=1.

For another example, assuming that the terminal reports the first layer number indication information, which includes maxRank-sTRP=2 and maxRank-SDM=2, the network device receives the second layer number indication information reported by the terminal, which includes maxRank′-sTRP=1 and max Rank′-SDM=2.

For another example, assuming that the terminal reports the first layer number indication information, which includes maxRank-sTRP=2 and maxRank-SDM=2, the network device receives the second layer number indication information reported by the terminal, which includes maxRank′-sTRP=1 and maxRank′-SDM=1.

In the above embodiment, the network device may receive the maximum transmission layer number actually supported by the terminal when the terminal performs the simultaneous multi-panel uplink transmission, which improves accuracy of configuring an SRS resource set by the network device, and has a high availability.

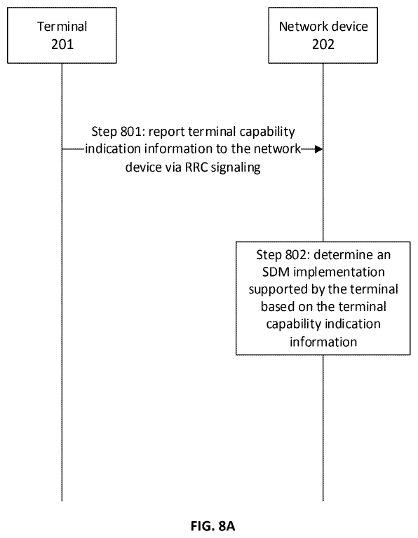

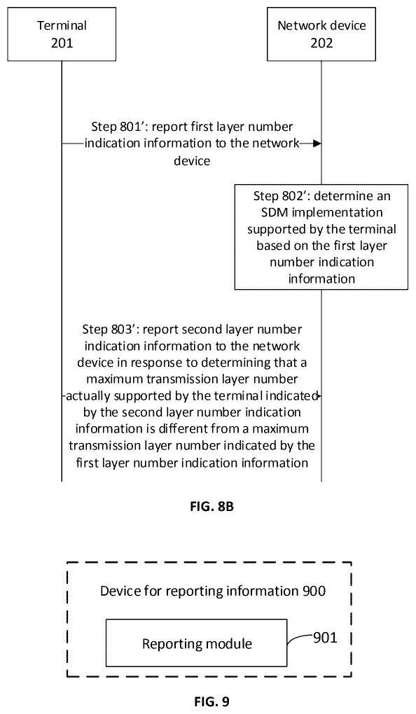

In some embodiments, as shown with reference to FIG. 8, it is a flowchart of a method for reporting and receiving information according to an embodiment. The method may be applied to the system shown in FIG. 2, and includes the following steps 801 and 802.

In step 801, a terminal reports terminal capability indication information to a network device via RRC signaling.

In one possible implementation, an SDM implementation is any one of a first SDM implementation or a second SDM implementation.

The first SDM implementation includes: a plurality of antenna ports deployed on multiple panels sharing a first number of baseband digital ports on the terminal, such as shown in FIG. 3A.

The second SDM implementation includes: the first number of antenna ports deployed on the multiple panels being in a fixed one-to-one correspondence with the first number of baseband digital ports, such as shown in FIG. 3B.

In one possible implementation, the terminal may report terminal capability information to the network device via the RRC signaling. The terminal capability indication information is configured to indicate one SDM implementation supported by the terminal.

For example, the terminal reports the terminal capability information via the RRC signaling, and the terminal capability indication information is configured to indicate that the terminal supports the first SDM implementation.

For example, the terminal reports the terminal capability information via the RRC signaling, and the terminal capability indication information is configured to indicate that the terminal supports the second SDM implementation.

In one example, the terminal may report one supported SDM implementation to the network device via an IE in the RRC signaling, for example:

UL_STxMP_SDMscheme {“scheme1”, “scheme2”}

where scheme1 is configured to indicate the first SDM implementation, and scheme2 is configured to indicate the second SDM implementation.

In step 802, the network device determines the SDM implementation supported by the terminal based on the terminal capability indication information.

In this step, the network device may directly determine the SDM implementation supported by the terminal based on the terminal capability indication information reported by the terminal.

For example, the terminal indicates “scheme1” in the IE of the RRC signaling, and then the network device determines that the SDM implementation supported by the terminal is the first SDM implementation. For another example, the terminal indicates “scheme2” in the IE, and then the network device determines that the SDM implementation supported by the terminal is the second SDM implementation.

In the above embodiment, the terminal may directly report the SDM implementation supported by the terminal via the RRC signaling, and the network device may configure an SRS resource set for the terminal based on the SDM implementation, which improves the feasibility and reliability of simultaneous multi-panel uplink transmission.

In some embodiments, as shown with reference to FIG. 8, it is a flowchart of a method for reporting and receiving information according to an embodiment. The method may be applied to the system shown in FIG. 2, and includes the following steps 801′ to 803′.

In step 801′, a terminal reports first layer number indication information to a network device.

Instead of directly reporting one SDM implementation supported by the terminal, the terminal may implicitly indicate one SDM implementation supported by the terminal via other reported information.

In some examples, the terminal may inform the network device of one SDM implementation supported by the terminal by reporting first layer number indication information. The first layer number indication information is configured to indicate a maximum transmission layer number supported for use by the terminal when the terminal is configured for simultaneous multi-panel uplink transmission.

The terminal may be supported to perform single-TRP transmission and M-TRP transmission under a configuration of simultaneous multi-panel uplink transmission. In the present disclosure, the M-TRP transmission mainly refers to an SDM transmission implementation.

In one example, the number of the maximum transmission layer numbers reported by the terminal via the first layer number indication information is a plurality. The first layer number indication information may be configured to respectively indicate:

a maximum transmission layer number supported by the terminal during the single-TRP transmission; and a maximum transmission layer number supported by the terminal when the terminal performs SDM transmission of the simultaneous multi-panel uplink transmission during the M-TRP transmission.

In the present disclosure, the maximum transmission layer number refers to a maximum MIMO transmission layer number configured by the network device for the terminal. The maximum transmission layer number is a maximum transmission layer number of the PUSCH.

For example, the terminal indicates, via maxRank, a maximum transmission layer number supported by the terminal during CB PUSCH transmission. The terminal may report maxRank-sTPR and maxRank-SDM. maxRank-sTPR is used for CB PUSCH transmission, and is configured to indicate the maximum transmission layer number supported by the terminal during the single-TRP transmission. maxRank-SDM is used for CB PUSCH transmission, and is configured to indicate the maximum transmission layer number supported by the terminal when the terminal performs the SDM transmission of the simultaneous multi-panel uplink transmission during the M-TRP transmission.

For example, the terminal indicates, via L_max, a maximum transmission layer number supported by the terminal during NCB PUSCH transmission. The terminal may report L_max-sTPR and L_max-SDM. L_max-sTPR is used for NCB PUSCH transmission, and is configured to indicate the maximum transmission layer number supported by the terminal during the single-TRP transmission. L_max-SDM is used for NCB PUSCH transmission, and is configured to indicate the maximum transmission layer number supported by the terminal when the terminal performs the SDM transmission of the simultaneous multi-panel uplink transmission during the M-TRP transmission.

For example, in a case where the terminal determines that the supported SDM implementation is the first SDM implementation, the number of the maximum transmission layer numbers indicated by the first layer number indication information reported to the network device may be a plurality, and the plurality of maximum transmission layer numbers are not equal.

For example, the terminal determines that the supported SDM implementation is the first SDM implementation. The terminal reports the first layer number indication information, which includes max Rank-sTPR=4 and maxRank-SDM=2.

For another example, the terminal determines that the supported SDM implementation is the first SDM implementation. The terminal reports the first layer number indication information, which includes L_max-sTPR=4 and L_max-SDM=2.

The above is merely an example illustration. In an actual application, the terminal may also report the first layer number indication information including other contents after determining the supported SDM implementation, which is not limited in the present disclosure.

For example, in a case where the terminal determines that the supported SDM implementation is the second SDM implementation, the number of the maximum transmission layer numbers indicated by the first layer number indication information reported to the network device may be a plurality, and the plurality of maximum transmission layer numbers are equal.

For example, the terminal determines that the supported SDM implementation is the second SDM implementation. The terminal reports the first layer number indication information, which includes max Rank-sTPR=2 and maxRank-SDM=2.

For another example, the terminal determines that the supported SDM implementation is the second SDM implementation. The terminal reports the first layer number indication information, which includes L_max-sTPR=2 and L_max-SDM=2.

In another example, in a case where the number of the maximum transmission layer numbers reported by the terminal via the first layer number indication information is 1, the first layer number indication information may be configured to indicate:
the maximum transmission layer number supported for use by the terminal during the single-TRP transmission being equal to the maximum transmission layer number supported for use by the terminal during the SDM transmission of the simultaneous multi-panel uplink transmission.

For example, the terminal may indicate the SDM implementation supported by the terminal via the reported number of the maximum transmission layer numbers.

For example, in a case where the terminal determines that the supported SDM implementation is the first SDM implementation, the number of the maximum transmission layer numbers indicated by the first layer number indication information reported to the network device may be a plurality. In such case, the plurality of maximum transmission layer numbers may be equal or may not be equal.

For example, the terminal determines that the supported SDM implementation is the first SDM implementation. The terminal reports the first layer number indication information, which includes maxRank-sTPR=4 and maxRank-SDM=2, or includes L_max-sTPR=2 and L_max-SDM=2.

For example, in a case where the terminal determines that the supported SDM implementation is the second SDM implementation, the number of the maximum transmission layer numbers indicated by the first layer number indication information reported to the network device may be 1.

For example, the terminal determines that the supported SDM implementation is the second SDM implementation. The terminal reports the first layer number indication information, which includes maxRank=2. In such case, the first layer number indication information indicates maxRank-sTPR=max Rank-SDM=2.

In step 802′, the network device determines the SDM implementation supported by the terminal based on the first layer number indication information.

The network device determines the SDM implementation supported by the terminal based on the first layer number indication information reported by the terminal.

In one example, in a case of determining that the number of the maximum transmission layer numbers indicated by the first layer number indication information reported by the terminal is a plurality, the network device may determine the SDM implementation supported by the terminal based on whether the plurality of maximum transmission layer numbers are the same.

For example, in a case of determining that the number of the maximum transmission layer numbers indicated by the first layer number indication information reported by the terminal is a plurality and the plurality of maximum transmission layer numbers are not equal, the network device may determine that the SDM implementation supported by the terminal is the first SDM implementation.

For example, the first layer number indication information reported by the terminal includes maxRank-sTPR=4 and max Rank-SDM=2. Since maxRank-sTPR and max Rank-SDM are not equal, the network device determines that the SDM implementation supported by the terminal is the first SDM implementation.

For example, in a case of determining that the number of the maximum transmission layer numbers indicated by the first layer number indication information reported by the terminal is a plurality and the plurality of maximum transmission layer numbers are equal, the network device may determine that the SDM implementation supported by the terminal is the second SDM implementation.

For example, the first layer number indication information reported by the terminal includes maxRank-sTPR=2 and maxRank-SDM=2. Since maxRank-sTPR and maxRank-SDM are equal, the network device determines that the SDM implementation supported by the terminal is the second SDM implementation.

In another example, the network device determines the SDM implementation supported by the terminal based on the number of the maximum transmission layer numbers indicated by the first layer number indication information reported by the terminal.

For example, in a case of determining that the number of the maximum transmission layer numbers indicated by the first layer number indication information reported by the terminal is a plurality, the network device may determine that the SDM implementation supported by the terminal is the first SDM implementation.

For example, the first layer number indication information reported by the terminal includes maxRank-sTPR=4 and maxRank-SDM=2. Since the number of the maximum transmission layer numbers indicated by the first layer number indication information is a plurality, the network device determines that the SDM implementation supported by the terminal is the first SDM implementation.

For example, in a case of determining that the number of the maximum transmission layer numbers indicated by the first layer number indication information reported by the terminal is 1, the network device may determine that the SDM implementation supported by the terminal is the second SDM implementation.

For example, the first layer number indication information reported by the terminal includes maxRank=2. Since the number of the maximum transmission layer numbers indicated by the first layer number indication information is 1, the network device determines that the SDM implementation supported by the terminal is the second SDM implementation. In such case, the first layer number indication information indicates maxRank-sTPR=maxRank-SDM=2.

In step 803′, the terminal reports second layer number indication information to the network device in response to determining that the maximum transmission layer number actually supported by the terminal indicated by the second layer number indication information is different from the maximum transmission layer number indicated by the first layer number indication information.

The implementation of step 803′ is similar to that of the above step 502, which is not repeated here. Step 803 is an optional step to be performed.

In the above embodiment, the terminal may inform the network device of the SDM implementation supported by the terminal by reporting the first layer number indication information, and the network device may configure an SRS resource set for the terminal based on the SDM implementation, which improves the feasibility and reliability of the simultaneous multi-panel uplink transmission.

Further examples of the above solution are described below.

For SDM implementations of STxMP transmission, an SDM implementation supported by a terminal includes any one of: a first SDM implementation or a second SDM implementation.

In the first SDM implementation, baseband digital ports are shared among individual panels, that is, the number of baseband sending links of the terminal is less than or equal to the total number of antenna ports of the collaborative panel, e.g., as shown in FIG. 3A, the baseband sending links may be connected with both of the two panels, and sending is performed dynamically on different panels according to each scheduling of a network device. The number of the baseband sending links corresponds to the total number of ports of the PUSCH. For example, in a case where four antenna ports are deployed on two panels respectively, the terminal may support transmission requirements under STRP and MTRP by up to four sending links. Such structure for the terminal may save the cost and efficiently achieve transmission of STxMP.

The second SDM implementation is defined as that the baseband digital ports are not shared among the individual panels, i.e., each baseband sending link of the terminal has a fixed physical connection with a different panel, e.g., as shown in FIG. 3B.

For the terminal:

in method 1, the terminal reports terminal capability indication information to the network device, and reports one SDM implementation supported by the terminal to the network device.

For example, RRC signaling for a specific capability of the terminal is defined in a protocol:

UL_STxMP_SDMscheme {“scheme1”, “scheme2”}.

In method 2, the terminal informs the network device of one SDM implementation supported by the terminal by reporting first layer number indication information.

In this method, the SDM implementation supported by the terminal may be distinguished by reporting of a maxRank or L_max parameter. maxRank or L_max is used to configure a maximum MIMO layer number parameter configured by the network device for a PUSCH sent corresponding to a TRP, panel, or Transmission Configuration Indication state (TCI state). maxRank is used for CB PUSCH transmission, and L_max is used for NCB PUSCH transmission.

In one example, the terminal fixedly reports a group of maxRank or L_max values supported by the terminal, which are configured to indicate the SDM implementation supported by the terminal.

In a case where the terminal supports the first SDM implementation, the reported two values (corresponding to STRP and MTRP respectively) are different.

For example, the terminal supports the first SDM implementation, and maxRank_sTRP=4 and maxRank_SDM=2 are reported.

In a case where the terminal supports the second SDM implementation, the reported two values are the same.

For example, the terminal supports the second SDM implementation, and maxRank_STRP=2 and maxRank_SDM=2 are reported.

In another example, the SDM implementation supported by the terminal is indicated by the number of reported max Rank values or L_max values.

In a case where the terminal supports the first SDM implementation, the terminal reports two maxRank values or two L_max values. For example, maxRank_sTRP=4 and maxRank_SDM=2.

In a case where the terminal supports the second SDM implementation, the terminal reports one maxRank value or one L_max value. For example, maxRank=2, which correspondingly indicates max Rank_sTRP=2 and maxRank_SDM=2.

Further, on the basis of the above method, the terminal may simultaneously report actually supported maxRank/L_max for actual scheduling requirements of the network device.

In a case where a maximum transmission layer number actually supported by the terminal under STRP/MTRP is the same as a maximum transmission layer number for determining the SDM implementation supported by the terminal in the above method 2, the terminal may no longer report the actual value.

In a case where the maximum transmission layer number actually supported by the terminal under STRP/MTRP is different from the reported maximum transmission layer number for determining the SDM implementation supported by the terminal in the method 2, the terminal may report corresponding actually supported parameter values simultaneously.

For example, the terminal reports that max Rank_sTRP is 2 and maxRank_SDM is also 2 according to the SDM implementation supported by the terminal, and then it may be determined that the terminal supports the second SDM implementation according to the reporting. However, the terminal actually reports that max Rank′_sTRP is 2 and maxRank′_SDM is 1 simultaneously, and then a transmission layer number corresponding to the SDM actually supported by the terminal is 2.

In the above embodiment, the feasibility and reliability of simultaneous multi-panel uplink transmission are improved.

Corresponding to the foregoing embodiments of application function implementation methods, the present disclosure further provides embodiments of application function implementation devices.

Referring to FIG. 9, FIG. 9 is a block diagram of a device 900 for reporting information according to an example. The device 900 is applied to a terminal and includes a reporting module 901.

The reporting module 901 is configured to report indication information to a network device. The indication information is configured to indicate an SDM implementation supported by the terminal when the terminal performs simultaneous multi-panel uplink transmission.

In some examples, the SDM implementation is any one of a first SDM implementation or a second SDM implementation.

The first SDM implementation includes: a plurality of antenna ports deployed on multiple panels sharing a first number of baseband digital ports on the terminal.

The second SDM implementation includes: the first number of antenna ports deployed on the multiple panels being in a fixed one-to-one correspondence with the first number of baseband digital ports.

In some examples, the reporting module 901 includes a first reporting sub-module.

The first reporting sub-module is configured to report terminal capability indication information to the network device via RRC signaling. The terminal capability indication information is configured to indicate one SDM implementation supported by the terminal.

In some examples, the reporting module 901 includes a second reporting sub-module.

The second reporting sub-module is configured to report first layer number indication information to the network device. The first layer number indication information is configured to indicate a maximum transmission layer number supported for use by the terminal when the terminal is configured for the simultaneous multi-panel uplink transmission.

In some examples, in a case where the number of the maximum transmission layer numbers indicated by the first layer number indication information is a plurality, the first layer number indication information is configured to respectively indicate:
a maximum transmission layer number supported by the terminal during single-TRP transmission; and
a maximum transmission layer number supported by the terminal when the terminal performs SDM transmission of the simultaneous multi-panel uplink transmission during M-TRP transmission.

In some examples, in a case where the number of the maximum transmission layer numbers indicated by the first layer number indication information is 1, the first layer number indication information is configured to indicate:
a maximum transmission layer number supported for use by the terminal during the single-TRP transmission being equal to a maximum transmission layer number supported for use by the terminal during SDM transmission of the simultaneous multi-panel uplink transmission.

In some examples, in a case where the SDM implementation is the first SDM implementation, the number of the maximum transmission layer numbers indicated by the first layer number indication information is a plurality, and the plurality of maximum transmission layer numbers are not equal; or
in a case where the SDM implementation is the second SDM implementation, the number of the maximum transmission layer numbers indicated by the first layer number indication information is a plurality, and the plurality of maximum transmission layer numbers are equal.

In some examples, in a case where the SDM implementation is the first SDM implementation, the number of the maximum transmission layer numbers indicated by the first layer number indication information is a plurality; or in a case where the SDM implementation is the second SDM implementation, the number of the maximum transmission layer numbers indicated by the first layer number indication information is 1.

In some examples, the reporting module 901 is further configured to:
report second layer number indication information to the network device. The second layer number indication information is configured to indicate a maximum transmission layer number actually supported by the terminal when the terminal performs the simultaneous multi-panel uplink transmission.

In some examples, the reporting module 901 includes a third reporting sub-module.

The third reporting sub-module is configured to report the second layer number indication information to the network device in response to determining that the maximum transmission layer number actually supported by the terminal indicated by the second layer number indication information is different from the maximum transmission layer number indicated by the first layer number indication information.

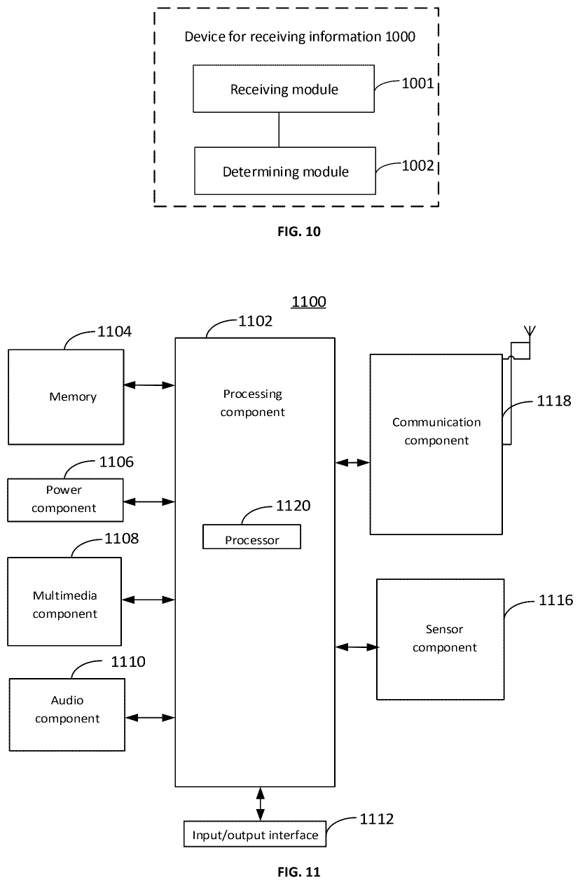

Referring to FIG. 10, FIG. 10 is a block diagram of a device 1000 for receiving information according to an example. The device 1000 is applied to a network device and includes a receiving module 1001 and a determining module 1002.

The receiving module 1001 is configured to receive indication information reported by a terminal, where the indication information is configured to indicate an SDM implementation supported by the terminal when the terminal performs simultaneous multi-panel uplink transmission; and The determining module 1002 is configured to determine the SDM implementation supported by the terminal based on the indication information.

In some examples, the SDM implementation is any one of a first SDM implementation or a second SDM implementation.

The first SDM implementation includes: a plurality of antenna ports deployed on multiple panels sharing a first number of baseband digital ports on the terminal.

The second SDM implementation includes: the first number of antenna ports deployed on the multiple panels being in a fixed one-to-one correspondence with the first number of baseband digital ports.

In some examples, the receiving module 1001 includes a first receiving sub-module.

The first receiving sub-module is configured to receive terminal capability indication information reported by the terminal via RRC signaling. The terminal capability indication information is configured to indicate one SDM implementation supported by the terminal.

In some examples, the receiving module 1001 includes a second receiving sub-module.

The second receiving sub-module is configured to receive first layer number indication information reported by the terminal. The first layer number indication information is configured to indicate a maximum transmission layer number supported for use by the terminal when the terminal is configured for the simultaneous multi-panel uplink transmission.

In some examples, the determining module 1002 includes any one of a first determining sub-module or a second determining sub-module.

The first determining sub-module is configured to determine that the SDM implementation is the first SDM implementation in response to determining that the number of the maximum transmission layer numbers indicated by the first layer number indication information is a plurality, and the plurality of maximum transmission layer numbers are not equal.

The second determining sub-module is configured to determine that the SDM implementation is the second SDM implementation in response to determining that the number of the maximum transmission layer numbers indicated by the first layer number indication information is a plurality, and the plurality of maximum transmission layer numbers are equal.

In some examples, the determining module 1002 includes any one of a third determining sub-module or a fourth determining sub-module.

The third determining sub-module is configured to determine that the SDM implementation is the first SDM implementation in response to determining that the number of the maximum transmission layer numbers indicated by the first layer number indication information is a plurality.

The fourth determining sub-module is configured to determine that the SDM implementation is the second SDM implementation in response to determining that the number of the maximum transmission layer numbers indicated by the first layer number indication information is 1.

In some examples, the receiving module 1001 is further configured to:
receive a second maximum layer number reported by the terminal. The second maximum layer number is a maximum transmission layer number actually supported by the terminal when the terminal performs the simultaneous multi-panel uplink transmission.

In some examples, the maximum transmission layer number actually supported by the terminal indicated by the second maximum layer number is different from a maximum transmission layer number indicated by the first layer number indication information.

As for the device embodiments, as they basically correspond to the method embodiments, the related parts may be referred to partial descriptions of the method embodiments. The device embodiments described above are merely illustrative. Units described above as separate components may or may not be physically separated, and components displayed as units may or may not be physical units, that is, they may be located in one place, or they may be distributed onto a plurality of network units. Part or all of the modules may be selected according to actual needs to implement the objective of the solution of the present disclosure. Those of ordinary skill in the art may understand and implement it without creative labor.

Correspondingly, the present disclosure further provides a computer-readable storage medium, storing a computer program. The computer program is configured to perform the method for reporting information of any one of the above.

Correspondingly, the present disclosure further provides a computer-readable storage medium, storing a computer program. The computer program is configured to perform the method for receiving information of any one of the above.

Correspondingly, the present disclosure further provides a device for reporting information, including:
a processor; and
a memory configured to store processor-executable instructions.

The processor is configured to perform the method for reporting information of any one of the above.

FIG. 11 is a block diagram of a device 1100 for reporting information according to an example. For example, the device 1100 may be a terminal such as a cell phone, a tablet computer, an e-book reader, a multimedia playback device, a wearable device, an in-vehicle user device, an ipad, a smart TV, etc.

Referring to FIG. 11, the device 1100 may include one or more of the following components: a processing component 1102, a memory 1104, a power component 1106, a multimedia component 1108, an audio component 1110, an input/output (I/O) interface 1112, a sensor component 1116, and a communication component 1118.

The processing component 1102 generally controls overall operations of the device 1100, such as operations associated with display, a telephone call, data random access, a camera operation, and a recording operation. The processing component 1102 may include one or more processors 1120 to execute instructions to complete all or part of the steps of the above method for reporting information. In addition, the processing component 1102 may include one or more modules to facilitate interaction between the processing component 1102 and other components. For example, the processing component 1102 may include a multimedia module to facilitate interaction between the multimedia component 1108 and the processing component 1102. For another example, the processing component 1102 may read executable instructions from the memory to implement the steps of the method for reporting information provided by the above embodiments.

The memory 1104 is configured to store various types of data to support operations on the device 1100. Examples of these data include instructions for any application or method operated on the device 1100, contact data, phonebook data, messages, pictures, videos, etc. The memory 1104 may be implemented by any type of volatile or non-volatile storage device or their combination, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a magnetic disk, or an optical disk.

The power component 1106 provides power for various components of the device 1100. The power component 1106 may include a power management system, one or more power supplies, and other components associated with generating, managing and distributing power for the device 1100.

The multimedia component 1108 includes a display providing an output interface between the device 1100 and a user. In some embodiments, the multimedia component 1108 includes at least one of a front camera or a rear camera. When the device 1100 is in an operation mode, such as a shooting mode or a video mode, at least one of the front camera or the rear camera may receive external multimedia data. Each front camera and rear camera may be a fixed optical lens system or have a focal length and an optical zoom capability.

The audio component 1110 is configured to output and/or input audio signals. For example, the audio component 1110 includes a microphone (MIC) configured to receive an external audio signal when the device 1100 is in the operation mode, such as a call mode, a recording mode, and a speech recognition mode. The received audio signal may be further stored in the memory 1104 or transmitted via the communication component 1118. In some embodiments, the audio component 1110 further includes a speaker for outputting an audio signal.

The I/O interface 1112 provides an interface between the processing component 1102 and a peripheral interface module. The above peripheral interface module may be a keyboard, a click wheel, a button, etc. These buttons may include but are not limited to: a home button, a volume button, a start button, and a lock button.

The sensor component 1116 includes one or more sensors for providing state assessment of various aspects for the device 1100. For example, the sensor component 1116 may detect an on/off state of the device 1100, and relative positioning of components, such as components being a display and a keypad of the device 1100. The sensor component 1116 may further detect a change in a position of the device 1100 or a component of the device 1100, presence or absence of contact of a user with the device 1100, an orientation or acceleration/deceleration of the device 1100, and a change in a temperature of the device 1100. The sensor component 1116 may include a proximity sensor configured to detect presence of nearby objects without any physical contact. The sensor component 1116 may further include an optical sensor, such as a CMOS or CCD image sensor, for use in imaging applications. In some embodiments, the sensor component 1116 may further include an acceleration sensor, a gyroscope sensor, a magnetic sensor, a pressure sensor, or a temperature sensor.

The communication component 1118 is configured to facilitate wired or wireless communication between the device 1100 and other devices. The device 1100 may access a wireless network based on a communication standard, such as Wi-Fi, 2G, 3G, 4G, 5G, 6G, or their combination. In an example, the communication component 1118 receives a broadcast signal or broadcast-related information from an external broadcast management system via a broadcast channel. In an example, the communication component 1118 further includes a near field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology, and other technologies.

In an example, the device 1100 may be implemented by one or more application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, or other electronic elements for performing any one of the above methods for reporting information by the terminal.

In an example, a non-transitory machine-readable storage medium including instructions, such as the memory 1104 including instructions, is further provided. The above instructions may be executed by the processor 1120 of the device 1100 to complete the above method for reporting information. For example, the non-transitory computer-readable storage medium may be a ROM, a random access memory (RAM), a CD-ROM, a magnetic tape, a floppy disk, an optical data storage device, etc.

Correspondingly, the present disclosure further provides a device for receiving information, including:
a processor; and
a memory configured to store processor-executable instructions.

The processor is configured to perform the method for receiving information of any one of the above.

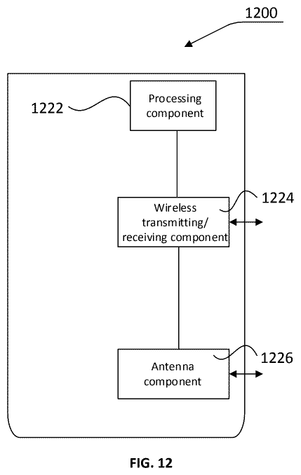

As shown in FIG. 12, FIG. 12 is a schematic diagram of a structure of a device 1200 for receiving information according to an example. The device 1200 may be provided as a network device. Referring to FIG. 12, the device 1200 includes a processing component 1222, a wireless transmitting/receiving component 1224, an antenna component 1226, and a signal processing part specific to the wireless interface. The processing component 1222 may further include at least one processor.

One processor in the processing component 1222 may be configured to perform the method for receiving information of any one of the above.

Other implementations of the present disclosure are apparent to those skilled in the art from consideration of the specification and practice of the present disclosure here. The present disclosure is intended to cover any variations, uses, or adaptations of the present disclosure. These variations, uses, or adaptations follow the general principles of the present disclosure and include common knowledge or conventional technical means in the technical field that is not disclosed in the present disclosure. The specification and embodiments are considered as examples merely, and the true scope and spirit of the present disclosure are indicated by the following claims.

It is to be understood that the present disclosure is not limited to the exact construction that has been described above and illustrated in the accompanying drawings, and that various modifications and changes may be made without departing from its scope. The scope of the present disclosure is merely limited by the appended claims.

1. A method for reporting information, performed by a terminal, the method comprising:
sending indication information to a network device, wherein the indication information is configured to indicate a space division multiplexing (SDM) implementation supported by the terminal when the terminal performs simultaneous multi-panel uplink transmission.

2. The method according to claim 1, wherein the SDM implementation comprises any one of the following:
a first SDM implementation, wherein the first SDM implementation comprises: a plurality of antenna ports deployed on multiple panels sharing a first number of baseband digital ports on the terminal; or
a second SDM implementation, wherein the second SDM implementation comprises: the first number of antenna ports deployed on the multiple panels being in a one-to-one correspondence with the first number of baseband digital ports.

3. The method according to claim 1, wherein sending the indication information to the network device comprises at least one of the following:
sending terminal capability indication information to the network device via radio resource control (RRC) signaling, wherein the terminal capability indication information is configured to indicate the SDM implementation supported by the terminal; or
sending first layer number indication information to the network device, wherein the first layer number indication information is configured to indicate a maximum transmission layer number supported for use by the terminal when the terminal is configured for the simultaneous multi-panel uplink transmission.

4. (canceled)

5. The method according to claim 3, wherein in a case where a number of maximum transmission layer numbers indicated by the first layer number indication information is a plurality, the first layer number indication information is configured to respectively indicate:
a maximum transmission layer number supported by the terminal during single-transmission reception point (TRP) transmission; and
a maximum transmission layer number supported by the terminal when the terminal performs SDM transmission of the simultaneous multi-panel uplink transmission during multi-TRP transmission.

6. The method according to claim 3, wherein a number of maximum transmission layer numbers indicated by the first layer number indication information is 1.

7. The method according to claim 6, wherein the first layer number indication information is configured to indicate:
a maximum transmission layer number supported for use by the terminal during single-transmission reception point (TRP) transmission being equal to a maximum transmission layer number supported for use by the terminal during SDM transmission of the simultaneous multi-panel uplink transmission.

8. The method according to claim 5, wherein in a case where the SDM implementation is a first SDM implementation, the number of the maximum transmission layer numbers indicated by the first layer number indication information is the plurality, and the plurality of maximum transmission layer numbers are not equal; or
in a case where the SDM implementation is a second SDM implementation, the number of the maximum transmission layer numbers indicated by the first layer number indication information is the plurality, and the plurality of maximum transmission layer numbers are equal.

9. The method according to claim 5, wherein in a case where the SDM implementation is a first SDM implementation, the number of the maximum transmission layer numbers indicated by the first layer number indication information is the plurality; or
in a case where the SDM implementation is a second SDM implementation, the number of the maximum transmission layer numbers indicated by the first layer number indication information is 1.

10. The method according to claim 3, further comprising:
sending second layer number indication information to the network device, wherein the second layer number indication information is configured to indicate a maximum transmission layer number actually supported by the terminal when the terminal performs the simultaneous multi-panel uplink transmission.

11. The method according to claim 10, wherein sending the second layer number indication information to the network device comprises:
sending the second layer number indication information to the network device in response to determining that the maximum transmission layer number actually supported by the terminal indicated by the second layer number indication information is different from the maximum transmission layer number indicated by the first layer number indication information.

12. A method for receiving information, performed by a network device, the method comprising:
receiving indication information sent by a terminal, wherein the indication information is configured to indicate a space division multiplexing (SDM) implementation supported by the terminal when the terminal performs simultaneous multi-panel uplink transmission; and
determining the SDM implementation supported by the terminal based on the indication information.

13. The method according to claim 12, wherein the SDM implementation comprises any one of the following:
a first SDM implementation, wherein the first SDM implementation comprises: a plurality of antenna ports deployed on multiple panels sharing a first number of baseband digital ports on the terminal; or
a second SDM implementation, wherein the second SDM implementation comprises: the first number of antenna ports deployed on the multiple panels being in a one-to-one correspondence with the first number of baseband digital ports.

14. The method according to claim 12, wherein receiving the indication information sent by the terminal comprises:
receiving terminal capability indication information sent by the terminal via radio resource control (RRC) signaling, wherein the terminal capability indication information is configured to indicate the SDM implementation supported by the terminal.

15. The method according to claim 12, wherein receiving the indication information sent by the terminal comprises:
receiving first layer number indication information sent by the terminal, wherein the first layer number indication information is configured to indicate a maximum transmission layer number supported for use by the terminal when the terminal is configured for the simultaneous multi-panel uplink transmission.

16. The method according to claim 15, wherein determining the SDM implementation based on the indication information comprises any one of the following:
determining that the SDM implementation is a first SDM implementation in response to determining that a number of maximum transmission layer numbers indicated by the first layer number indication information is a plurality, and the plurality of maximum transmission layer numbers are not equal; or
determining that the SDM implementation is a second SDM implementation in response to determining that the number of the maximum transmission layer numbers indicated by the first layer number indication information is the plurality, and the plurality of maximum transmission layer numbers are equal.

17. The method according to claim 15, wherein determining the SDM implementation based on the indication information comprises any one of the following:
determining that the SDM implementation is a first SDM implementation in response to determining that a number of maximum transmission layer numbers indicated by the first layer number indication information is a plurality; or
determining that the SDM implementation is a second SDM implementation in response to determining that the number of the maximum transmission layer numbers indicated by the first layer number indication information is 1.

18. The method according to claim 15, further comprising:
receiving a second maximum layer number sent by the terminal, wherein the second maximum layer number is a maximum transmission layer number actually supported by the terminal when the terminal performs the simultaneous multi-panel uplink transmission.

19. The method according to claim 18, wherein the maximum transmission layer number actually supported by the terminal indicated by the second maximum layer number is different from a maximum transmission layer number indicated by the first layer number indication information.

20-23. (canceled)

24. A device for reporting information, comprising:
a processor; and
a memory configured to store processor-executable instructions;
wherein the processor is configured to execute the processor-executable instructions to:
send indication information to a network device, wherein the indication information is configured to indicate a space division multiplexing (SDM) implementation supported by a terminal when the terminal performs simultaneous multi-panel uplink transmission.

25. A device for receiving information, comprising:
a processor; and
a memory configured to store processor-executable instructions;
wherein the processor is configured to execute the processor-executable instructions to perform the method for receiving information according to claim 12.
